(19) United States
(12) Patent Application Publication
(10) Pub. No.: US 2016/0181007 A1
(43) Pub. Date: Jun. 23, 2016

(54) COIL COMPONENT AND METHOD OF MAKING THE SAME

(71) Applicant: MURATA MANUFACTURING CO., LTD., Kyoto-fu (JP)

(72) Inventors: Noboru SHIOKAWA, Nagaokakyo-shi (JP); Ryota HASHIMOTO, Nagaokakyo-shi (JP); Shinya HIRAI, Nagaokakyo-shi (JP); Shinichiro BANBA, Nagaokakyo-shi (JP); Mitsuyoshi NISHIDE, Nagaokakyo-shi (JP); Tatsuya SASAKI, Nagaokakyo-shi (JP); Shin HASEGAWA, Nagaokakyo-shi (JP)

(73) Assignee: MURATA MANUFACTURING CO., LTD., Kyoto-fu (JP)

(21) Appl. No.: 14/969,990

(22) Filed: Dec. 15, 2015

(30) Foreign Application Priority Data
Dec. 19, 2014 (JP) 2014-258018
Apr. 17, 2015 (JP) 2015-085348
Sep. 2, 2015 (JP) 2015-173165

(51) Int. Cl. H01F 27/28; H01F 27/32; H01F 41/02; H01F 27/30; H01F 41/04

(52) U.S. Cl. CPC H01F 27/2828; H01F 27/2895; H01F 27/306; H01F 41/04; H01F 41/02; H01F 27/324

(57) ABSTRACT

A coil component includes a core and a coil that is wound around the core. The coil includes a plurality of pin members that are joined together.

### CROSS REFERENCE TO RELATED APPLICATIONS

This application claims benefit of priority to Japanese Patent Application 2014-258018 filed Dec. 19, 2014, to Japanese Patent Application 2015-085348 filed Apr. 17, 2015, and to Japanese Patent Application No. 2015-173165 filed Sep. 2, 2015, the entire content of which is incorporated herein by reference.

### TECHNICAL FIELD

The present disclosure relates to a coil component and a method of making the coil component.

### BACKGROUND

Examples of existing coil components include a coil component described in Japanese Unexamined Patent Application Publication No. 11-97249. This coil component includes a toroidal core and a wire that is wound around the toroidal core.

In the coil component, the wire is manually wound around the toroidal core. Therefore, it is difficult to make the distance between adjacent turns of the wire be constant. Accordingly, in each coil component, variation in the stray capacitance between turns of the wire occurs, and variation in characteristics occurs.

### SUMMARY

Accordingly, it is an object of the present disclosure to provide a coil component that can reduce variation in characteristics and a method of making the coil component.

According to preferred embodiments of the present disclosure, a coil component includes a core and a coil that is wound around the core. The coil includes a plurality of pin members that are joined together.

With the coil component, the coil includes the plurality of pin members that are joined together. Thus, the plurality of pin members can be attached to the core in an aligned state, so that the distance between pin members that are adjacent to each other in the axial direction of the coil can be easily maintained constant. Accordingly, in each coil component, variation in the stray capacitance between adjacent pin members can be reduced, and variation in characteristics can be reduced.

In the coil component according to preferred embodiments, the plurality of pin members may be joined together by using a joining material.

The joining material is, for example, a solder, plating, a conductive adhesive, or a conductive paste. The conductive adhesive and the conductive paste contain silver powder or copper powder.

In this case, because the plurality of pin members are joined together by using the joining material, the plurality of pin members can be joined together after the pin members have been disposed at predetermined positions on the core. Thus, the coil component is easy to assemble.

In the coil component according to preferred embodiments, at least some of the pin members that are adjacent to each other in an axial direction of the coil may be isolated from each other with a space therebetween.

The term “axial direction of the coil” refers to the direction in which the helix of the coil extends.

In this case, because at least some of adjacent pin members are isolated from each other with a space therebetween, compared with a case where all regions between adjacent pin members are filled with a filler, such as a resin, stress applied to the core due to the filler can be reduced and magnetostriction can be reduced.

In the coil component according to preferred embodiments, at least some of the pin members that are adjacent to each other in an axial direction of the coil may be isolated from each other with a dielectric material therebetween.

The term “axial direction of the coil” refers to the direction in which the helix of the coil extends.

In this case, because at least some of adjacent pin members are isolated from each other with a dielectric material therebetween, reduction in the magnetic force can be reduced due to the presence of the dielectric material.

In the coil component according to preferred embodiments, the plurality of pin members may include a plurality of first pin members and a plurality of second pin members. The first pin members and the second pin members have different shapes and are alternately joined together.

In this case, because the plurality of pin members include the plurality of first pin members and the plurality of second pin members having different shapes, for example, the shapes of the first and second pin members can be determined in accordance with the shape of the core. Accordingly, the coil can be made from two types of pin members, and the pin members can be easily attached to the core. For example, the pin members of two types may be angular pins or round pins or may be pins having different lengths.

In the coil component according to preferred embodiments, the first pin members may be bent pins that are substantially U-shaped and the second pin members may be straight pins that extend substantially straight.

The meaning of the term “substantially U-shaped” includes the meanings of “U-shaped”, “V-shaped”, and “semiarc-shaped”. The meaning of the term “substantially straight” includes the meanings of “along a straight line” and “along a line that is only slightly bent or curved”.

In this case, the first pin members are bent pins, and the second pin members are straight pins. Accordingly, by attaching the bent pins to the core so as to be hooked around the core, the bent pins can be attached appropriately.

In the coil component according to preferred embodiments, the core may be annular, and the coil component may further include a holding member that holds the coil, the holding member being disposed between at least one of two end surfaces of the core in an axial direction of the core and a part of the coil that faces the at least one of the two end surfaces of the core.

In this case, because the holding member holds the coil, the distance between pin members that are adjacent to each other in the axial direction of the coil can be maintained constant, and thereby variation in characteristics can be further reduced. The meaning of the term “annular core” includes the meaning of a cylindrical core and a core whose outer peripheral surface or an inner peripheral surface is elliptical, polygonal, or the like.

In the coil component according to preferred embodiments, the holding member may be disposed between each of the two end surfaces of the core in the axial direction of the core and a part of the coil that faces a corresponding one of the two end surfaces of the core.

In this case, because the holding member is disposed on each of the two end surfaces of the core in the axial direction of the core, the distance between pin members that are adjacent to each other in the axial direction of the coil can be maintained constant. Moreover, because positioning of the pin members can be stably performed, adjacent pin members can be more reliably joined together.

In the coil component according to preferred embodiments, the holding member may be an insulating substrate.

In this case, because the holding member is the insulating substrate, the holding member can electrically insulate the coil from the end surface of the core.

The coil component according to preferred embodiments may further include an insulating member that is disposed on each of an inner peripheral surface and an outer peripheral surface of the core.

In this case, because the insulating member is disposed on each of the inner peripheral surface and the outer peripheral surface of the core, the insulating member can electrically insulate the coil from the inner peripheral surface and the outer peripheral surface of the core.

In the coil component according to preferred embodiments, the insulating member may be an insulating tape.

In this case, the insulating member, which is the insulating tape, can be easily affixed to each of the inner peripheral surface and the outer peripheral surface of the core.

A coil component according to preferred embodiments includes an annular core; a coil that is wound around the core; and a holding member that holds the coil, the holding member being disposed between at least one of two end surfaces of the core in an axial direction of the core and a part of the coil that faces the at least one of the two end surfaces of the core.

With the coil component, because the holding member holds the coil, the distance between turns of the coil that are adjacent to each other in the axial direction of the coil can be maintained constant. Accordingly, in each coil component, variation in the stray capacitance between turns of coil that are adjacent to each other in the axial direction of the coil can be reduced, and variation in characteristics can be reduced. The meaning of the term “annular core” includes the meaning of a cylindrical core and a core whose outer peripheral surface or an inner peripheral surface is elliptical, polygonal, or the like.

In the coil component according to preferred embodiments, the holding member may be disposed between each of the two end surfaces of the core in the axial direction of the core and a part of the coil that faces a corresponding one of the two end surfaces of the core.

In this case, because the holding member is disposed on each of the two end surfaces of the core in the axial direction, the distance between turns of the coil that are adjacent to each other in the axial direction of the coil can be maintained constant. Moreover, because positioning of the pin members can be stably performed, adjacent pin members can be more reliably joined together.

In the coil component according to preferred embodiments, the holding member may be an insulating substrate.

In this case, because the holding member is the insulating substrate, the holding member can electrically insulate the coil from the end surface of the core.

The coil component according to preferred embodiments may further include an insulating member that is disposed on each of an inner peripheral surface and an outer peripheral surface of the core.

In this case, because the insulating member is disposed on each of the inner peripheral surface and the outer peripheral surface of the core, the insulating member can electrically insulate the coil from the inner and outer peripheral surfaces of the core.

In the coil component according to preferred embodiments, the insulating member is an insulating tape.

In this case, the insulating member, which is the insulating tape, can be easily affixed to the inner peripheral surface and the outer peripheral surface of the core.

In the coil component according to preferred embodiments, the coil may include a plurality of pin members that are joined together.

In this case, the coil includes the plurality of pin members that are joined together. Thus, the plurality of pin members can be attached to the core in an aligned state, so that the distance between pin members that are adjacent to each other in the axial direction of the coil can be easily made constant. Accordingly, in each coil component, variation in the stray capacitance between adjacent pin members can be reduced, and variation in characteristics can be reduced.

A method of making a coil component according to preferred embodiments includes a step of attaching a plurality of first pin members to a core; and a step of forming a coil, which is wound around the core, from the plurality of first pin members and a plurality of second pin members by joining the second pin members to the first pin members so that the first pin members and the second pin members are alternately arranged.

With the method of making a coil component, the plurality of first pin members are attached to the core; and the coil, which is wound around the core, is formed by joining the plurality of second pin members to the plurality of first pin members so that the first pin members and the second pin members are alternately arranged. Thus, the plurality of pin members can be attached to the core in an aligned state, so that the distance between pin members that are adjacent to each other in the axial direction of the coil can be easily made constant. Accordingly, in each coil component, variation in the stray capacitance between adjacent pin members can be reduced, and variation in characteristics can be reduced.

With the coil component and the method of making the coil component according to preferred embodiments of the present disclosure, because the coil includes the plurality of pin members that are joined together, the distance between adjacent pin members can be made constant and variation in characteristics can be reduced.

Other features, elements, characteristics and advantages of the present disclosure will become more apparent from the following detailed description of preferred embodiments of the present disclosure with reference to the attached drawings.

### BRIEF DESCRIPTION OF THE DRAWINGS

FIG. 1 is a perspective view of a coil component according to a first embodiment of the present disclosure.

FIG. 2 is an exploded perspective view of the coil component.

FIG. 3 is a perspective view of the coil component from which some members of the coil component are omitted.

FIG. 4 is an enlarged plan view of a coil.

FIG. 5A illustrates a method of making the coil component.

FIG. 5B illustrates the method of making the coil component.

FIG. 5C illustrates the method of making the coil component.

FIG. 5D illustrates the method of making the coil component.

FIG. 5E illustrates the method of making the coil component.

FIG. 5F illustrates the method of making the coil component.

FIG. 5G illustrates the method of making the coil component.

FIG. 5H illustrates the method of making the coil component.

FIG. 5I illustrates the method of making the coil component.

FIG. 5J illustrates the method of making the coil component.

FIG. 5K illustrates the method of making the coil component.

FIG. 6 is a perspective view of a coil component according to a second embodiment of the present disclosure.

FIG. 7 is an exploded perspective view of the coil component.

FIG. 8 is a plan view of the coil component from which some members of the coil component are omitted.

FIG. 9 is a perspective view of the coil component from which a cover member is removed.

FIG. 10A illustrates a method of making the coil component.

FIG. 10B illustrates the method of making the coil component.

FIG. 10C illustrates the method of making the coil component.

FIG. 10D illustrates the method of making the coil component.

FIG. 10E illustrates the method of making the coil component.

FIG. 10F illustrates the method of making the coil component.

FIG. 10G illustrates the method of making the coil component.

FIG. 11 is perspective view of a coil component according to a third embodiment of the present disclosure.

FIG. 12A illustrates a method of making the coil component.

FIG. 12B illustrates the method of making the coil component.

FIG. 12C illustrates the method of making the coil component.

FIG. 12D illustrates the method of making the coil component.

FIG. 12E illustrates the method of making the coil component.

FIG. 12F illustrates the method of making the coil component.

FIG. 12G illustrates the method of making the coil component.

FIG. 12H illustrates the method of making the coil component.

### DETAILED DESCRIPTION

Hereinafter, embodiments of the present disclosure will be described in detail with reference to the drawings.

### First Embodiment

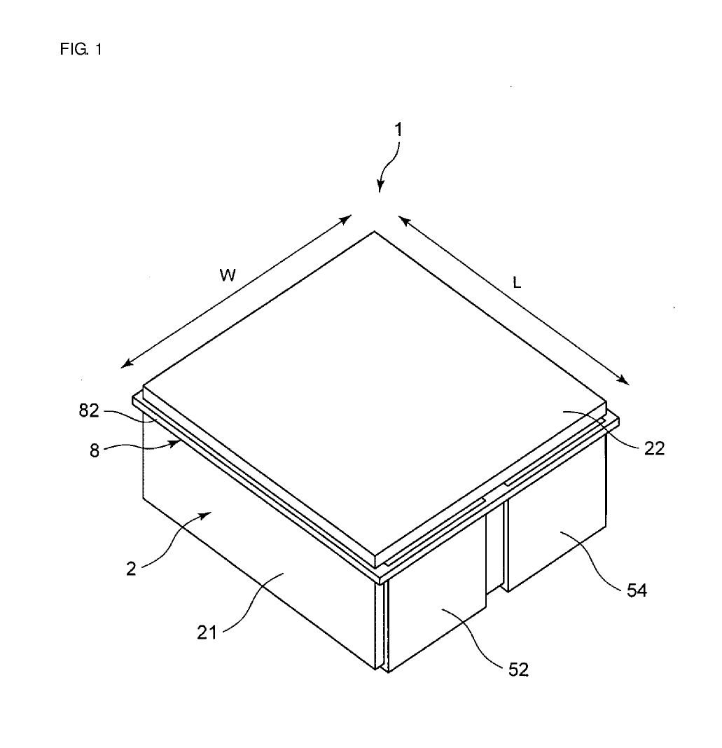

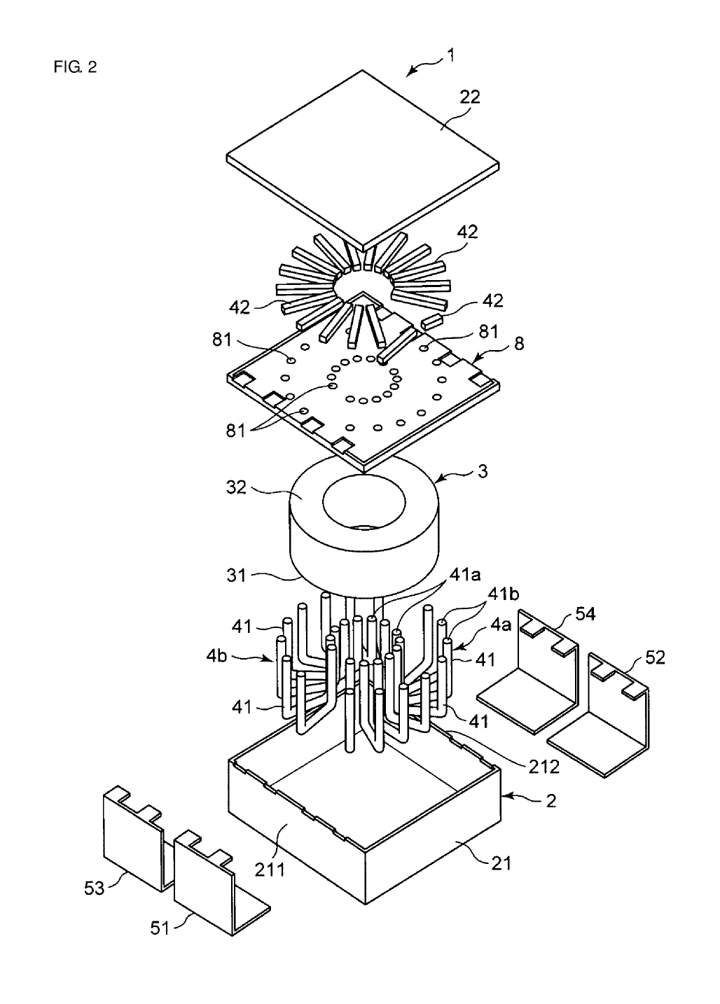

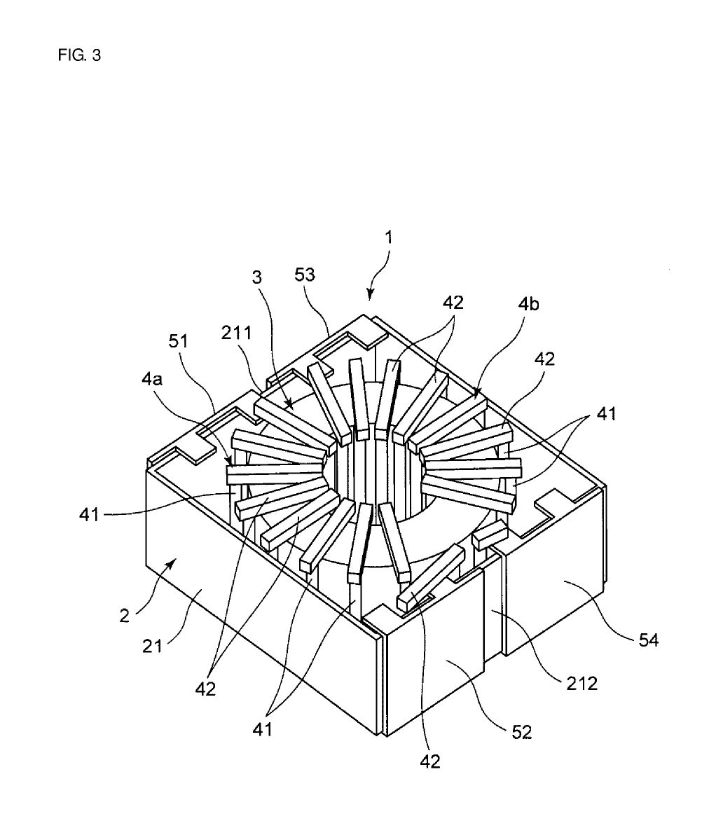

FIG. 1 is a perspective view of a coil component 1 according to a first embodiment of the present disclosure. FIG. 2 is an exploded perspective view of the coil component 1. FIG. 3 is a perspective view of the coil component 1 from which some members of the coil component 1 are omitted.

As illustrated in FIGS. 1 to 3, the coil component 1 includes a case 2, a core 3 disposed in the case 2, first to fourth electrode terminals 51 to 54 attached to the case 2, and a primary coil 4a and a secondary coil 4b, which are wound around the core 3 and connected to the first to fourth electrode terminals 51 to 54. The coil component 1 functions as, for example, a choke coil or a transformer.

The case 2 is rectangular-parallelepiped-shaped. The case 2 includes a bottom case 21 having a box-like shape and a top case 22 having a plate-like shape. The top case 22 is attached to the opening side of the bottom case 21. The case 2 is made of, for example, a resin, such as PPS, or ceramics.

The first electrode terminal 51 and the third electrode terminal 53 are attached to a first side surface 211 of the bottom case 21. The second electrode terminal 52 and the fourth electrode terminal 54 are attached to a second side surface 212 of the bottom case 21, which faces the first side surface 211. The first electrode terminal 51 and the second electrode terminal 52 are disposed so as to face each other. The third electrode terminal 53 and the fourth electrode terminal 54 are disposed so as to face each other.

The core 3 is a toroidal core and has a cylindrical shape. The core 3 is, for example, a ceramic core, such as a ferrite core, or a metal core. The core 3 has a first end surface 31 and a second end surface 32, which face each other in the axial direction. The first end surface 31 of the core 3 faces the bottom surface of the bottom case 21. The second end surface 32 of the core 3 faces the top case 22. Spacers (not shown) may be affixed to the second end surface 32 of the core 3. By using the spacers, the height of the core 3 in the axial direction of the core 3 can be adjusted.

The primary coil 4a is wound around the core 3 between the first electrode terminal 51 and the second electrode terminal 52. A first end of the primary coil 4a is connected to the first electrode terminal 51, and a second end of the primary coil 4a is connected to the second electrode terminal 52.

The secondary coil 4b is wound around the core 3 between the third electrode terminal 53 and the fourth electrode terminal 54. A first end of the secondary coil 4b is connected to the third electrode terminal 53, and a second end of the secondary coil 4b is connected to the fourth electrode terminal 54.

The winding direction of the primary coil 4a around the core 3 is opposite to the winding direction of the secondary coil 4b around the core 3. The number of turns of the primary coil 4a is the same as the number of turns of the secondary coil 4b.

Each of the primary coil 4a and the secondary coil 4b includes a plurality of first pin members 41 and a plurality of second pin members 42. The plurality of first and second pin members 41 and 42 are joined together by using a joining material. The first pin members 41 and the second pin members 42 are alternately joined together. That is, for a pair of adjacent first pin members 41, a first end of a second pin member 42 is connected to a first end of one of the first pin members 41, and a second end of the second pin member 42 is connected to a first end of the other first pin member 41. By repeating this operation, the plurality of first and second pin members 41 and 42 are helically wound around the core 3.

The first and second pin members 41 and 42 are made of, for example, a conductive material, such as pure copper. The joining material is, for example, a solder, plating, a conductive adhesive, or a conductive paste. The joining material includes powder of copper, which is the same as the material of the first and second pin members 41 and 42. The first and second pin members 41 and 42 may be joined together by welding instead of using a joining material.

The first pin members 41 and the second pin members 42 have different shapes. The first pin members 41 are bent pins that are substantially U-shaped. The second pin members 42 are straight pins extending substantially straight. In the present specification, the meaning of the term “substantially U-shaped” includes the meanings of “U-shaped”, “V-shaped”, and “semiarc-shaped”. The meaning of the term “substantially straight” includes the meanings of “along a straight line” and “along a line that is only slightly bent or curved”. With such shapes, as illustrated in FIG. 3, one first pin member 41 and one second pin member 42 constitute a unit element of one turn.

The first pin members 41 are fitted onto the core 3 from the first end surface 31 of the core 3 so that an inner peripheral surface and an outer peripheral surface of the core 3 are located between branched portions of each of the first pin members 41. The second pin members 42 are disposed so as to face the second end surface 32 of the core 3. The first and second pin members 41 and 42 are arranged in the axial direction of the coils 4a and 4b. The axial direction of the coils 4a and 4b is the direction in which the helices of the coils 4a and 4b extend. In this case, the axial direction of the coils 4a and 4b coincides with the circumferential direction of the core 3.

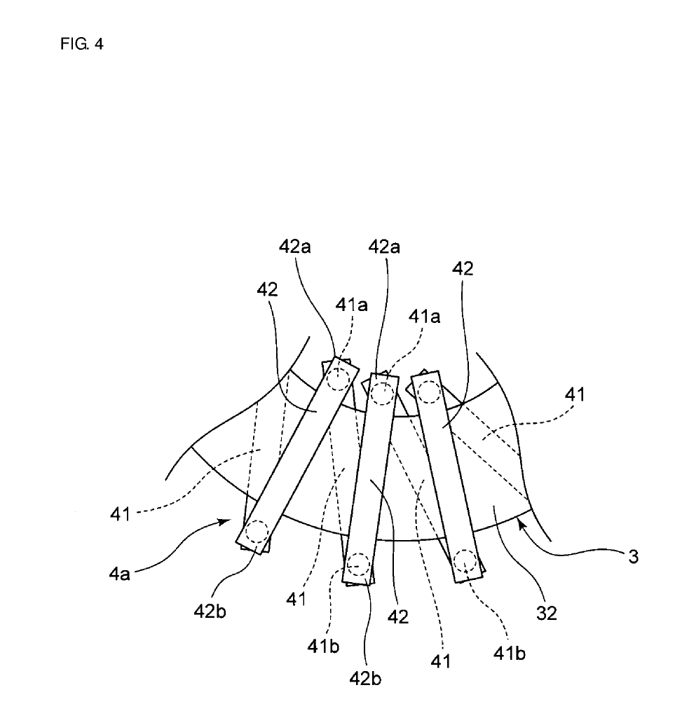

FIG. 4 is an enlarged plan view of the primary coil 4a. The secondary coil 4b has the same structure. As illustrated in FIG. 4, first end portions 41a of the first pin members 41 are located inside the core 3, and second end portions 41b of the first pin members 41 are located outside the core 3. First end portions 42a of the second pin members 42 are located inside the core 3, and second end portions 42b of the second pin members 42 are located outside the core 3.

For a pair of first pin members 41 that are located adjacent to each other in the axial direction of the coil 4a, a first end portion 42a of the second pin member 42 is joined to a first end portion 41a of one of the first pin members 41, and a second end portion 42b of the same second pin member 42 is joined to a second end portion 41b of the other first pin member 41. Thus, one of the first pin members 41, the second pin member 42, and the other first pin member 41 are connected in series.

First pin members 41 that are adjacent to each other in the axial direction of the coil 4a are isolated from each other with spaces therebetween. Likewise, second pin members 42 that are adjacent to each other in the axial direction of the coil 4a are isolated from each other with spaces therebetween. Thus, compared with a case where all regions between adjacent first pin members 41 and all regions between adjacent second pin members 42 are filled with filler, stress applied to the core 3 due to the filler can be reduced and magnetostriction can be reduced.

Alternatively, adjacent first pin members 41 or adjacent second pin members 42 may be isolated from each other with a conductive material, instead of a space, therebetween. The conductive material is, for example, a resin including a metal filler (composed of copper, silver, or the like). In this case, reduction in magnetic force can be prevented due to the presence of the dielectric material.

As illustrated in FIG. 2, a holding member 8 is interposed between the plurality of second pin members 42 and the core 3. The holding member 8 is made of, for example, a resin. The holding member 8 has a plurality of holes 81. The end portions 41a and 41b of the plurality of first pin members 41 are inserted into the plurality of holes 81, so that the end portions 41a and 41b are held by the holding member 8. The end portions 41a and 41b of the first pin member 41 are exposed from the holes 81, so that the end portions 41a and 41b of the first pin member 41 can be connected to the end portions 42a and 42b of the second pin member 42. Because the holding member 8 holds the plurality of first pin members 41 in this way, while maintaining the distance between adjacent first pin members 41 constant, the distance between adjacent second pin members 42, which are connected to the first pin members 41, can be maintained constant.

As illustrated in FIG. 1, the holding member 8 has a peripheral edge 82 corresponding to the outline of the coil component 1 when seen from above the top case 22 (that is, in a plan view). That is, the peripheral edge 82 is located outside the outer surface of the case 2 and the electrode terminals 51 to 54. The electrode terminals 51 to 54 extend into the holding member 8. Thus, the outside dimensions (the length H and the width W) of the coil component 1 are the same as those of the peripheral edge 82 of the holding member 8. By making the outside dimensions of the coil component 1 be the same as those of the peripheral edge 82 of the holding member 8, the outside dimensions of the coil component 1 can be easily set. Moreover, the size of the coil component 1 can be easily detected by using a reflection sensor or a through-beam sensor, so that the accuracy of mounting the coil component 1 on a circuit board can be increased.

Next, a method of making the coil component 1 will be described.

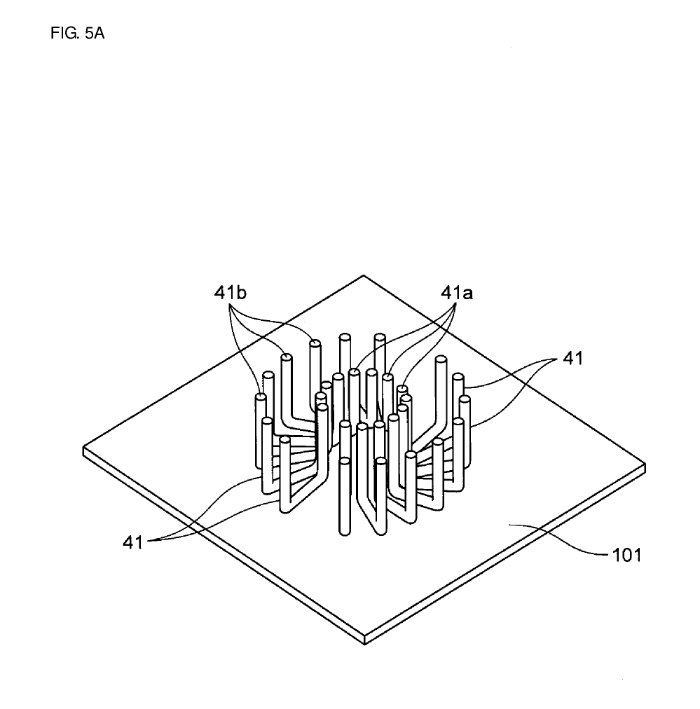

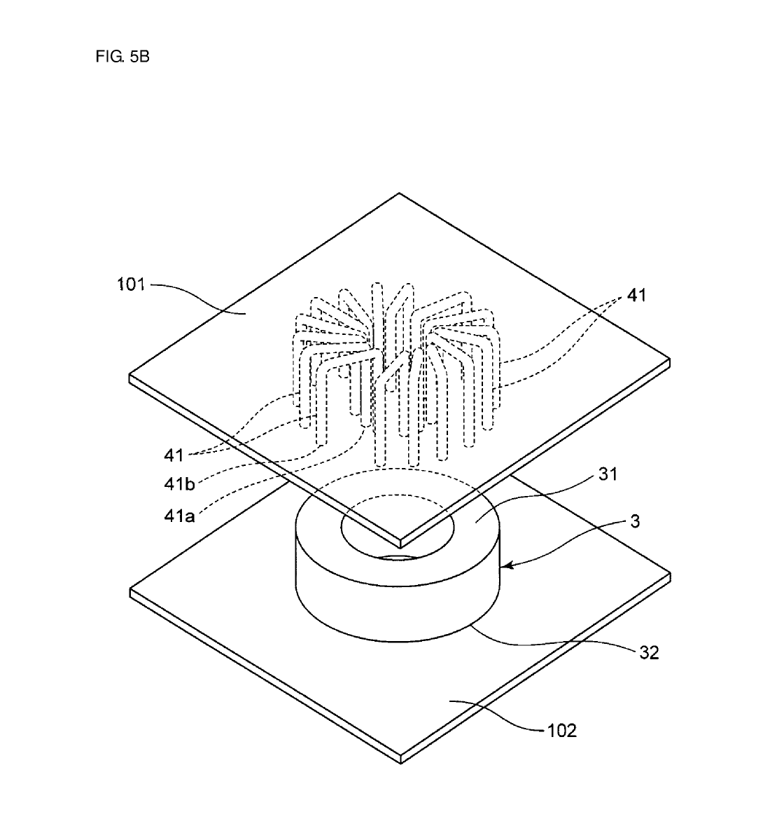

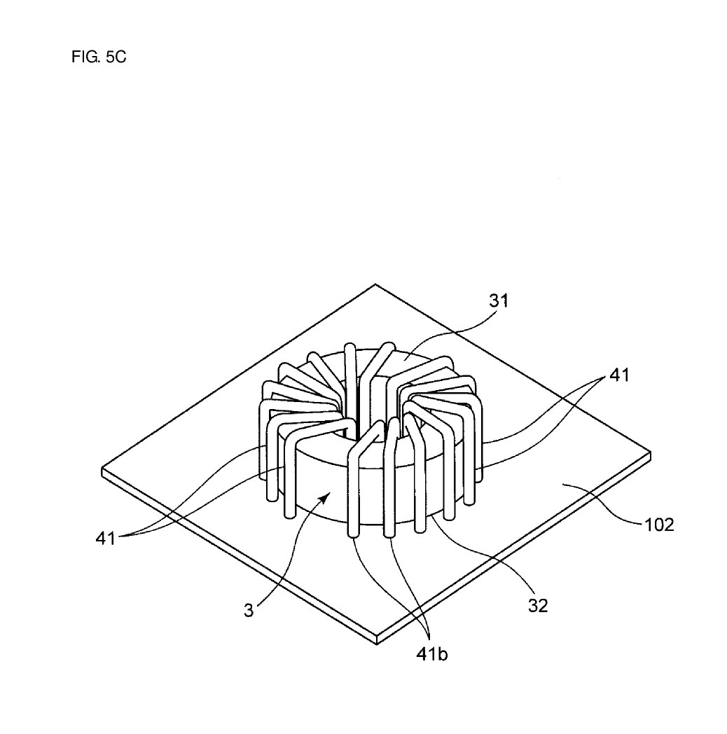

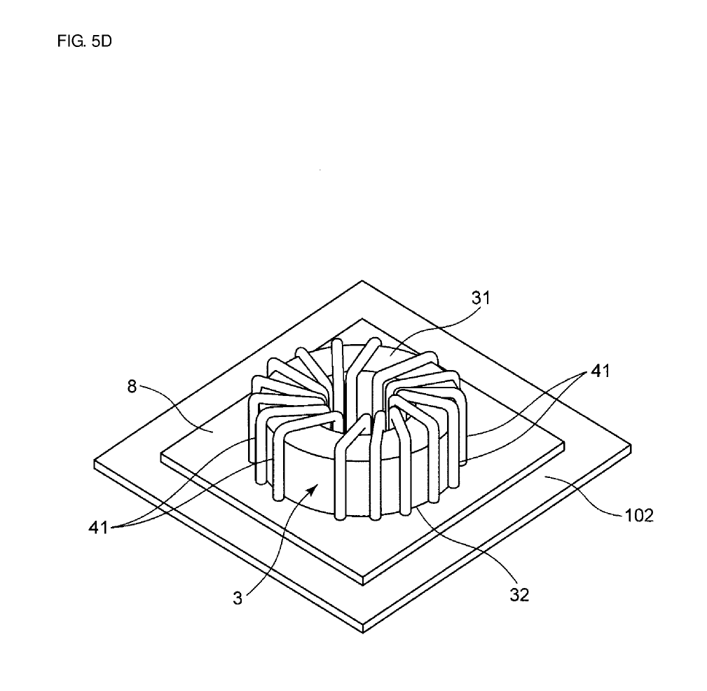

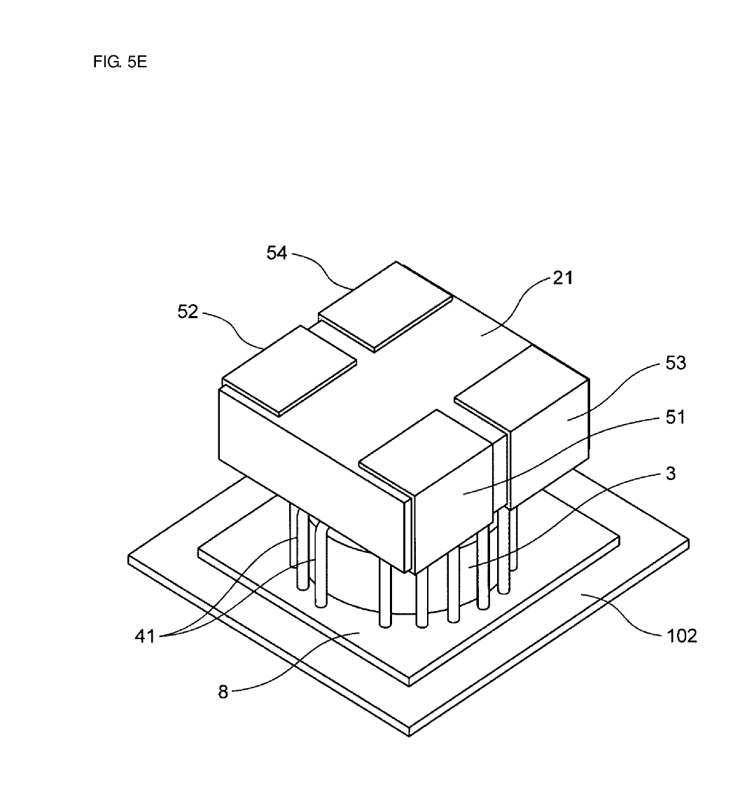

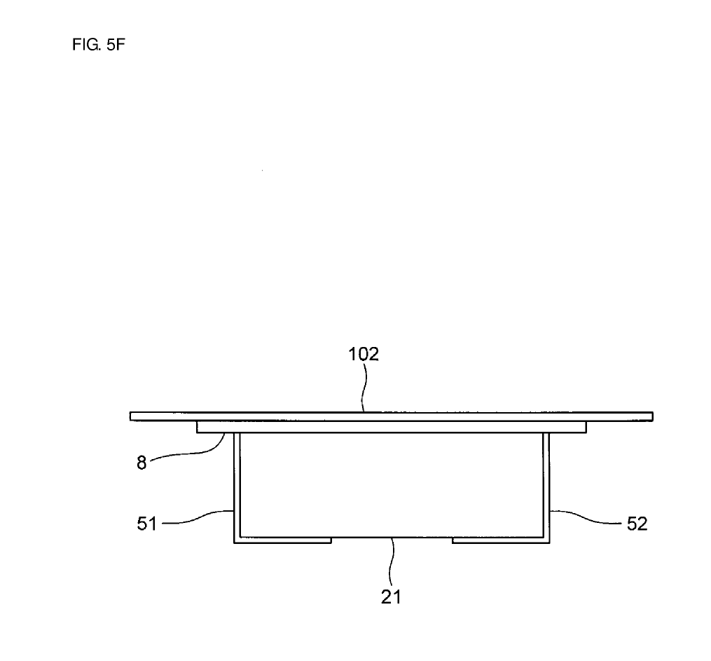

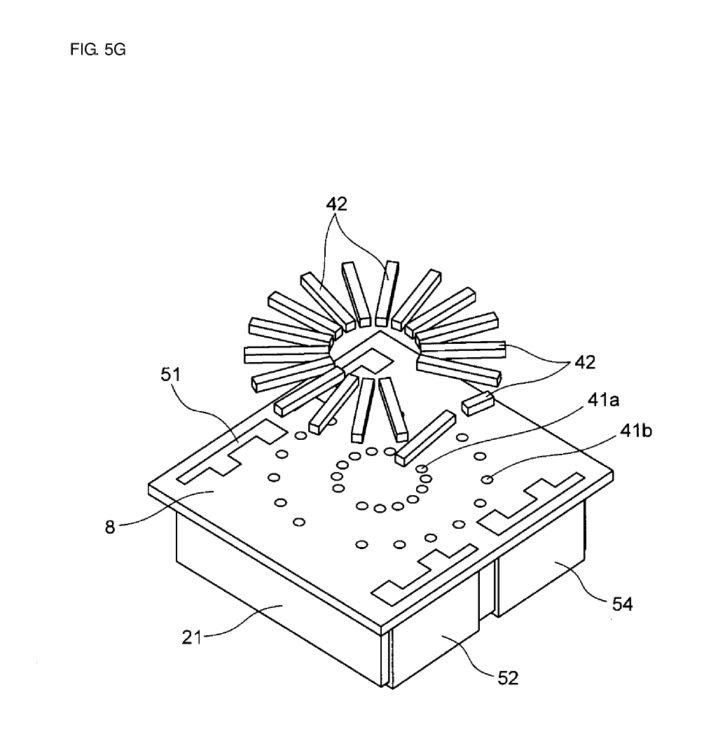

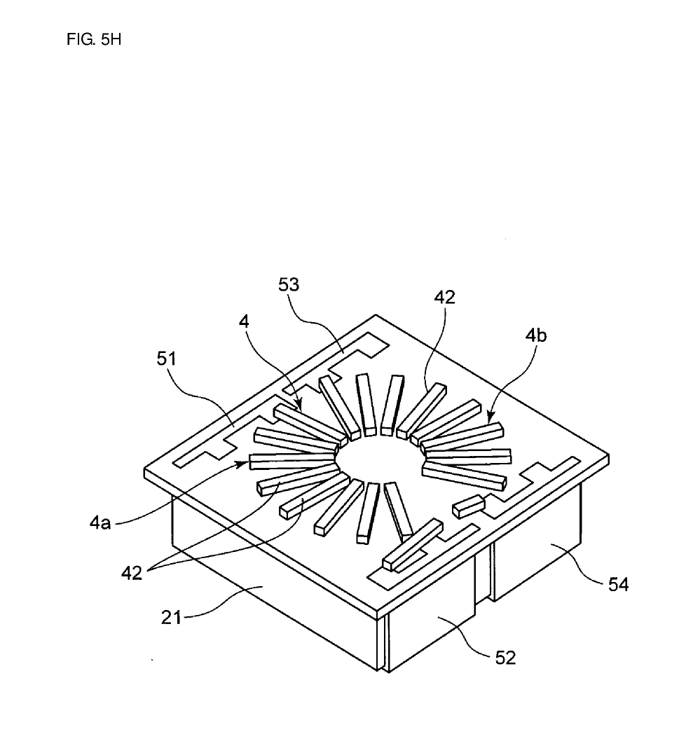

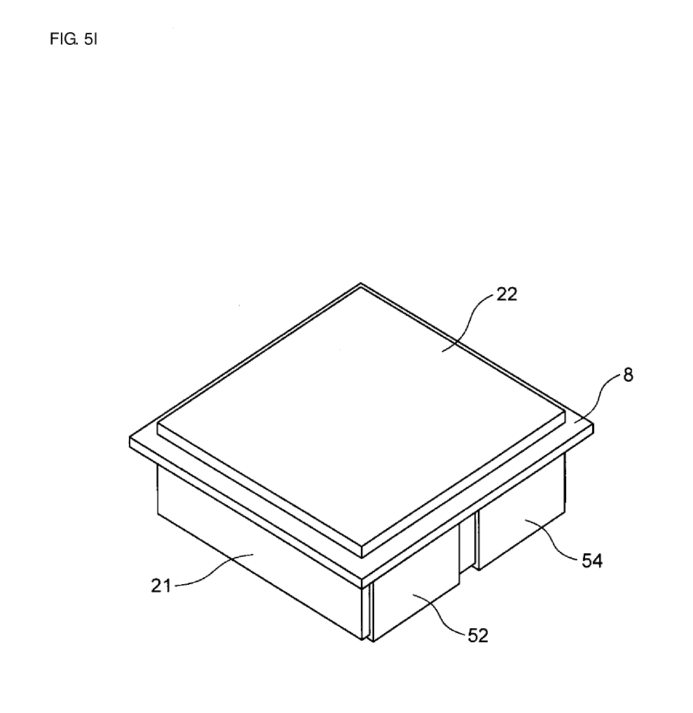

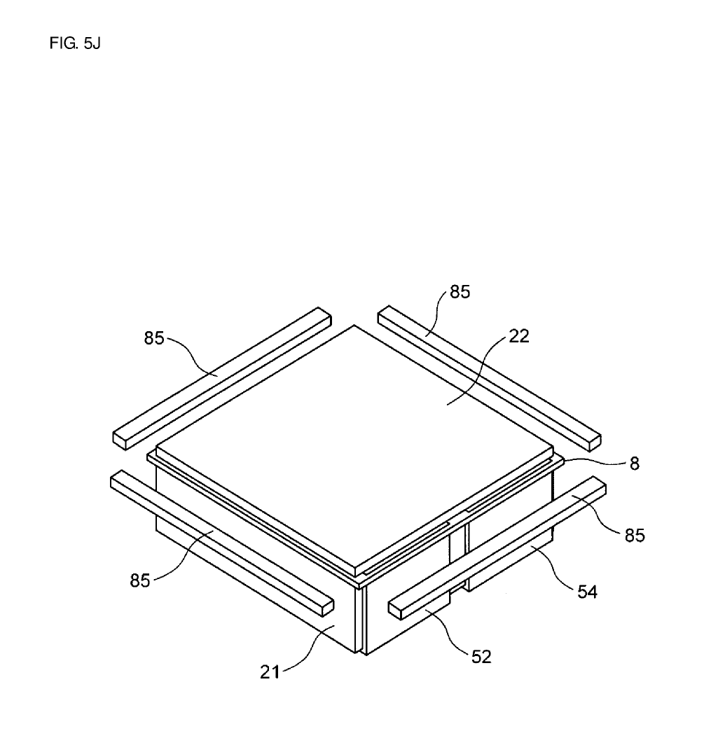

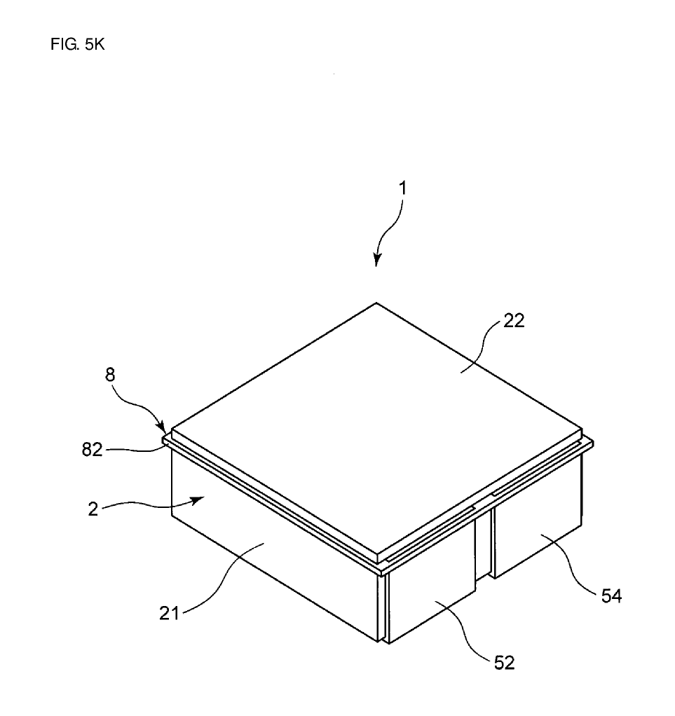

As illustrated in FIG. 5A, the plurality of first pin members 41 are affixed to the upper surface of a temporary fixing sheet 101 so as to be temporarily fixed in place. At this time, the plurality of first pin members 41 are disposed so that the end portions 41a and 41b of the first pin members 41 face upward. The plurality of first pin members 41 are arranged so that the first end portions 41a of the first pin members 41 are located along the inner peripheral surface of the core 3 and the second end portions 41b of the first pin members 41 are located along the outer peripheral surface of the core 3. The plurality of first pin members 41 are arranged so that the distance between adjacent first pin members 41 is constant. An adhesive has been applied to the upper surface of the temporary fixing sheet 101. Therefore, by only placing the plurality of first pin members 41, which have been aligned with high accuracy beforehand, on the upper surface of the temporary fixing sheet 101, the aligned state of the plurality of first pin members 41 can be maintained.

Subsequently, as illustrated in FIG. 5B, the second end surface 32 of the core 3 is placed on the upper surface of a base sheet 102. The plurality of first pin members 41, which have been affixed to the temporary fixing sheet 101, are fitted onto the first end surface 31 of the core 3 so that the first end portions 41a of the first pin members 41 are located inside the core 3 in the radial direction of the core 3 and the second end portions 41b of the first pin members 41 are located outside the core 3 in the radial direction of the core 3. Thus, the plurality of first pin members 41 can be attached to the core 3 in an aligned state. Accordingly, the distance between first pin members 41 that are adjacent to each other in the circumferential direction of the core 3 can be easily made constant.

As illustrated in FIG. 5C, the temporary fixing sheet 101 is removed from the plurality of first pin members 41, which have been attached to the core 3. At this time, the end portions 41a and 41b of the first pin member 41 protrude from the second end surface 32 of the core 3. A gap is formed between the second end surface 32 of the core 3 and the base sheet 102. As illustrated in FIG. 5D, the holding member 8 is inserted into the gap. At this time, the gap is filled with the holding member 8, which has softness. The end portions 41a and 41b of the first pin member 41 are buried in the holding member 8.

Subsequently, as illustrated in FIG. 5E, the bottom case 21, to which the electrode terminals 51 to 54 have been attached, is placed so as to cover the core 3. At this time, parts of the electrode terminals 51 to 54 and a part of the bottom case 21 are buried in the holding member 8, which has softness. By solidifying the holding member 8, the bottom case 21 and the first pin member 41 are integrated with each other with the holding member 8 therebetween. Thus, the plurality of first pin members 41 are held by the holding member 8, and the distance between adjacent first pin members 41 is maintained constant.

Subsequently, grinding is performed from the lower side of the base sheet 102 (from above in FIG. 5F) as illustrated in FIG. 5F to expose the end portions 41a and 41b of the first pin members 41 and parts of the electrode terminals 51 to 54 from the holding member 8 as illustrated in FIG. 5G. The plurality of second pin members 42 are arranged on the upper surface of the holding member 8 and joined to the plurality of first pin members 41. At this time, the first pin members 41 and the second pin members 42 are alternately joined together. Because the second pin member 42 are connected to the first pin member 41, which have been aligned, the distance between adjacent second pin members 42 can be maintained constant.

As illustrated in FIG. 5H, the coils 4a and 4b, which are wound around the core 3, are formed from the first pin members 41 and the second pin members 42. Subsequently, as illustrated in FIG. 5I, the top case 22 is attached to the opening side of the bottom case 21. At this time, the holding member 8 is interposed between the bottom case 21 and the top case 22, and the holding member 8 extends beyond the edges of the bottom case 21 and the top case 22 in a plan view.

Subsequently, as illustrated in FIG. 5J, excess portions 85 of the holding member 8, which extend beyond the edges of the cases 21 and 22, are cut off. As a result, the coil component 1 illustrated in FIG. 5K is obtained. At this time, the excess portions 85 of the holding member 8 are cut so that the peripheral edge 82 of the holding member 8 is positioned further outward than any other members of the coil component 1 in a plan view. Thus, the size of the peripheral edge 82 of the holding member 8 can be made to be the same as the outside dimensions of the coil component 1.

In the coil component 1, each of the coils 4a and 4b is made by joining the plurality of pin members 41 and 42 together. Thus, the plurality of pin members 41 and 42 can be attached to the core 3 while positioning and aligning the pin members 41 and 42 with high accuracy not manually but by using a feeding device or the like; and the distance between adjacent pin members 41 and 42 in the axial direction of the coils 4a and 4b can be easily made constant. Accordingly, variation in the stray capacitance between adjacent pin members 41 and 42 in each coil component 1 can be reduced, and variation in characteristics can be reduced.

Because the plurality of pin members 41 and 42 are joined together by using a joining material, the plurality of pin members 41 and 42 can be joined together by using the joining material after the pin members 41 and 42 have been attached to the core 3. Thus, the coil component 1 is easy to assemble.

Because the plurality of pin members 41 and 42 include the plurality of first pin members 41 and the plurality of second pin members 42, for example, the shapes of the first and second pin members 41 and 42 can be determined in accordance with the shape of the core 3. Accordingly, the coils 4a and 4b can be made from two types of pin members 41 and 42, and the pin members 41 and 42 can be easily attached to the core 3.

The first pin members 41 are substantially U-shaped bent pins, and the second pin members 42 are straight pins. Accordingly, by fitting the bent pins onto the core 3 from the first end surface 31 side, the bent pins can be appropriately attached.

In the method of making the coil component 1, the coils 4a and 4b, which are wound around the core 3, are formed by attaching the plurality of first pin members 41 to the core 3 and by joining each of the plurality of second pin members 42 to a pair of first pin members 41 that are adjacent to the second pin member 42. Thus, the plurality of pin members can be attached to the core 3 in an aligned state, and the distance between adjacent pin members 41 and 42 in the axial direction of the coils 4a and 4b can be easily made constant. Accordingly, variation in the stray capacitance between adjacent pin members 41 and 42 in each coil component 1 can be reduced, and variation in characteristics can be reduced. In particular, because the temporary fixing sheet 101 and the holding member 8 are used, as described above, the distance between adjacent pin members 41 and 42 can be easily maintained constant.

Because the coils 4a and 4b, which are wound around the core 3, can be formed by only attaching the plurality of first pin members 41 to the core 3 and joining the plurality of second pin members 42 to the plurality of first pin members 41, productivity is improved compared with existing methods in which a coil is made by manually winding a wire. Moreover, the production process can be automated, and improvement in production accuracy and cost reduction can be achieved.

### Second Embodiment

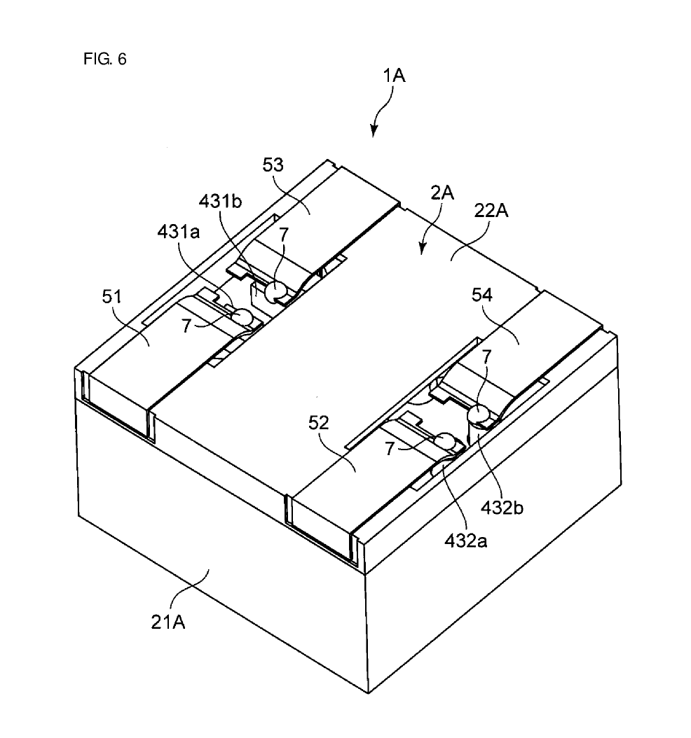

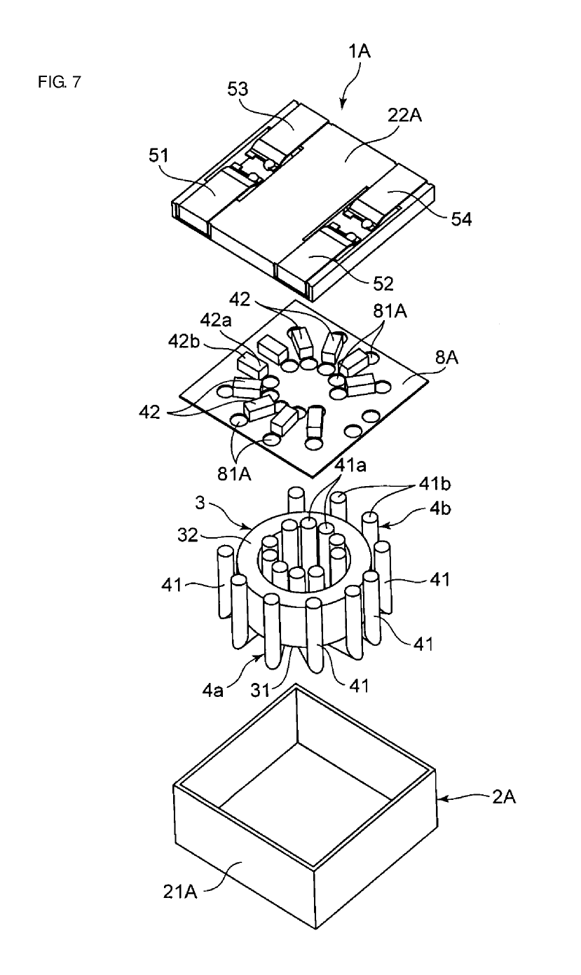

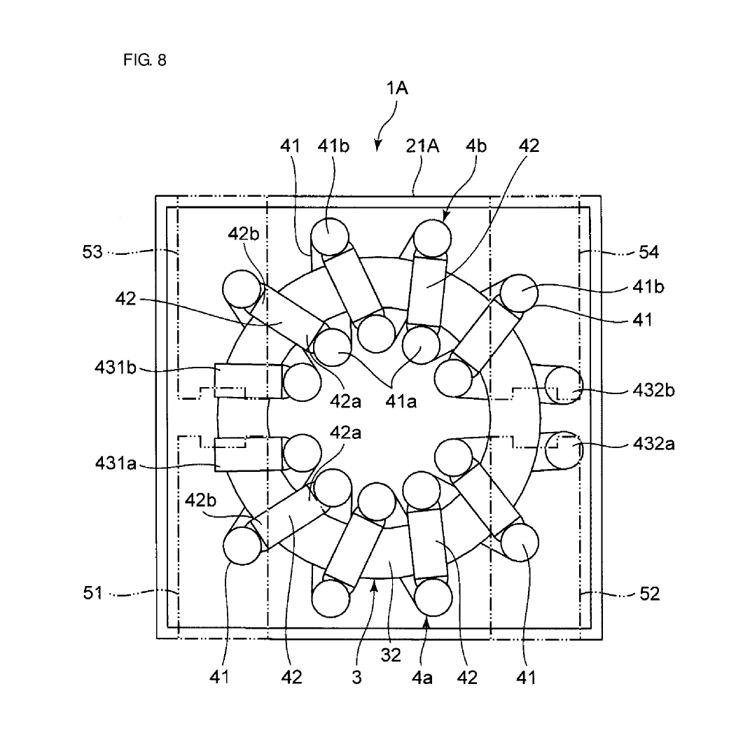

FIG. 6 is a perspective view of a coil component 1A according to a second embodiment of the present disclosure. FIG. 7 is an exploded perspective view of the coil component 1A. FIG. 8 is a plan view of the coil component 1A from which some members of the coil component 1A are omitted. The coil component 1A according to the second embodiment differs from the coil component 1 according to the first embodiment in the position at which the electrode terminals are attached and in the way in which the coils are attached to the holding member.

As illustrated in FIGS. 6 to 8, the coil component 1A includes a case 2A, a core 3 disposed in the case 2A, first to fourth electrode terminals 51 to 54 attached to the case 2A, and a primary coil 4a and a secondary coil 4b, which are wound around the core 3 and connected to the electrode terminals 51 to 54.

The case 2A includes a box 21A having an opening and a cover member 22A attached to the opening of the box 21A. The core 3 is disposed in the box 21A. The first to fourth electrode terminals 51 to 54 are attached to the cover member 22A. The first electrode terminal 51 and the second electrode terminal 52 are disposed adjacent to each other in the direction in which one side of the rectangular shape of the cover member 22A extends. The third electrode terminal 53 and the fourth electrode terminal 54 are disposed adjacent to each other in the direction in which one side of the rectangular shape of the cover member 22A extends. The first electrode terminal 51 and the third electrode terminal 53 are disposed so as to face each other in a direction in which the other side of the rectangular shape of the cover member 22A extends. The second electrode terminal 52 and the fourth electrode terminal 54 face each other in a direction in which the other side of the rectangular shape of the cover member 22A extends.

The core 3 is disposed in the box 21A. The first end surface 31 of the core 3 faces the bottom surface of the box 21A. The second end surface 32 of the core 3 faces the cover member 22A.

The primary coil 4a is wound around the core 3 between the first electrode terminal 51 and the second electrode terminal 52. The primary coil 4a includes a first end portion 431a and a second end portion 432a. The first end portion 431a is connected to the first electrode terminal 51 through a joining member 7. The second end portion 432a is connected to the second electrode terminal 52 through a joining member 7. The joining member 7 is, for example, a solder. The primary coil 4a and the first and second electrode terminals 51 and 52 may be joined together not through the joining members 7 but by welding.

Likewise, the secondary coil 4b is wound around the core 3 between the third electrode terminal 53 and the fourth electrode terminal 54. The secondary coil 4b includes a first end portion 431b and a second end portion 432b. The first end portion 431b is connected to the third electrode terminal 53 through a joining member 7. The second end portion 432b is connected to the fourth electrode terminal 54 through a joining member 7.

As in the first embodiment, each of the primary coil 4a and the secondary coil 4b includes a plurality of first pin members 41 and second pin members 42. The first pin members 41 are substantially U-shaped bent pins. The second pin members 42 are straight pins that extend substantially straight.

The first and second pin members 41 and 42 are joined together by using a joining material. The joining material is, for example, a solder. The first and second pin members 41 and 42 may be joined together by welding instead of using a joining material.

For a pair of adjacent first pin members 41, a first end portion 42a of a second pin member 42 is joined to a first end portion 41a of one of the first pin members 41, and a second end portion 42b of the second pin member 42 is joined to a second end portion 41b of the other first pin member 41. By repeating this operation, the plurality of first and second pin members 41 and 42 are helically wound around the core 3. That is, one first pin member 41 and one second pin member 42 constitute a unit element of one turn.

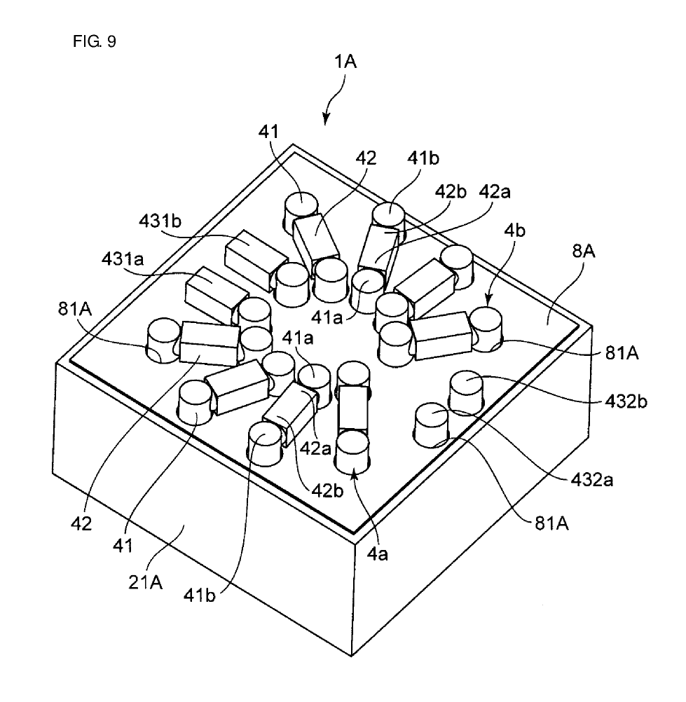

FIG. 9 is a perspective view of the coil component 1A from which the cover member 22A is removed. As illustrated in FIG. 9, the first and second end portions 41a and 41b of the first pin members 41 are inserted into holes 81A of a holding member 8A. The first and second end portions 41a and 41b protrude from the holes 81A. The second pin members 42 are placed on the upper surface of the holding member 8A. The second pin members 42 are interposed between the first and second end portions 41a and 41b, which protrude from the holes 81A. Connection portions between the first pin members 41 and the second pin members 42 are perpendicular to the upper surface of the holding member 8A.

Because the first and second end portions 41a and 41b are inserted into the holes 81A so as to protrude from the holes 81A, in contrast to the first embodiment, it is not necessary to grind the holding member to expose the end surfaces of the first and second end portions from the holding member. Moreover, because the connection portions between the first pin members 41 and the second pin members 42 are perpendicular to the upper surface of the holding member 8A, the connection portions can be easily checked.

Next, a method of making the coil component 1A will be described.

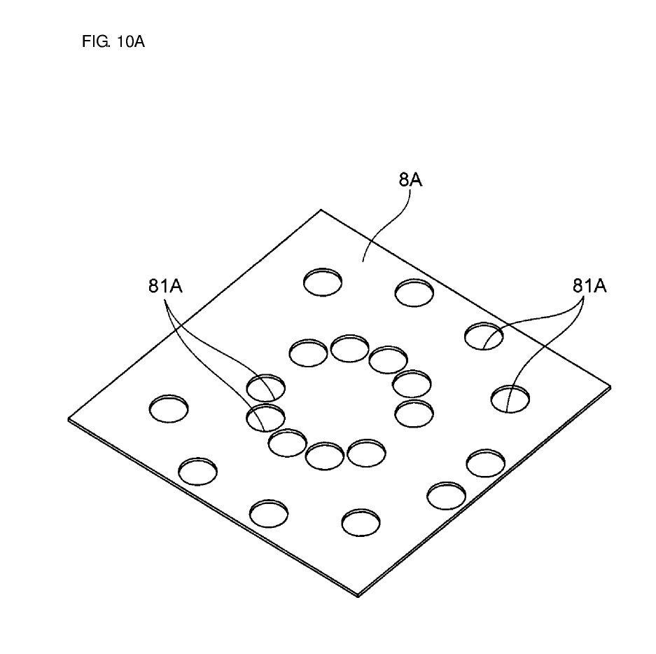

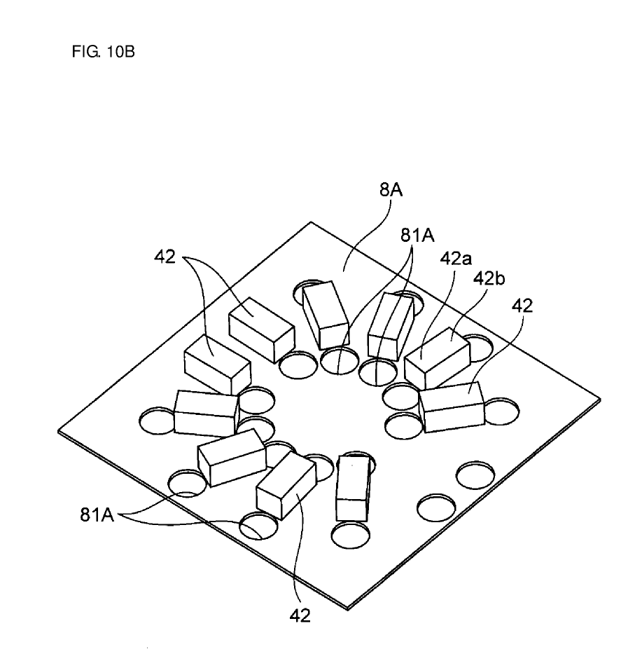

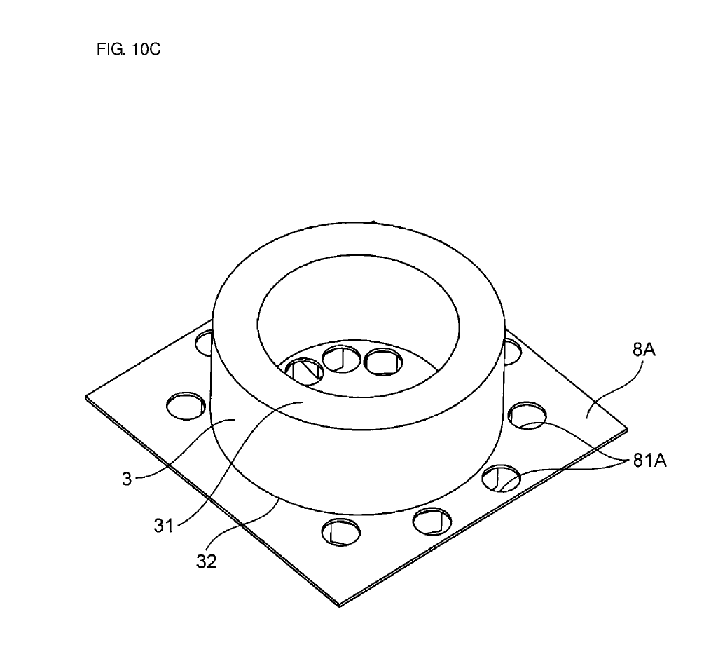

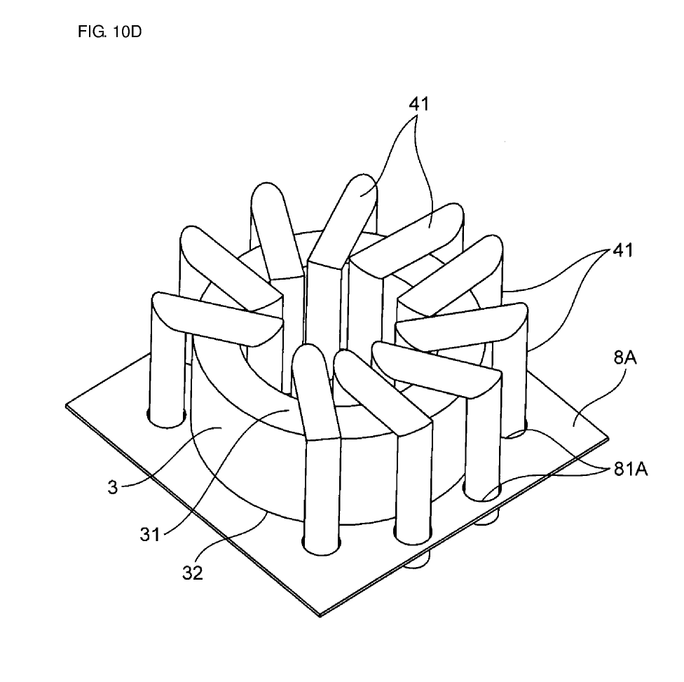

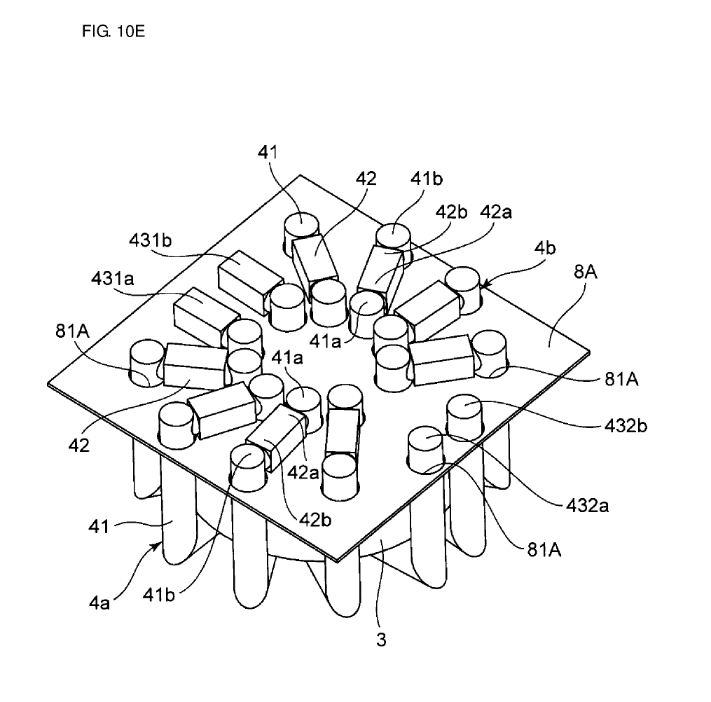

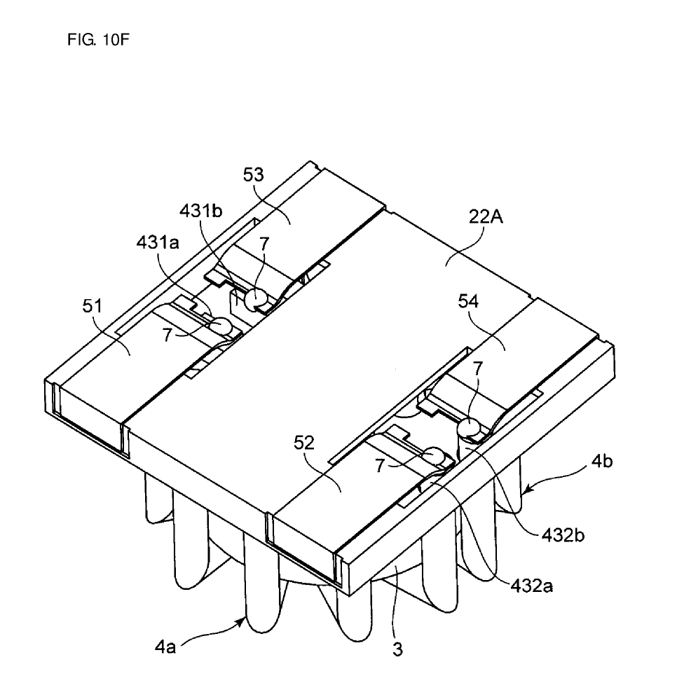

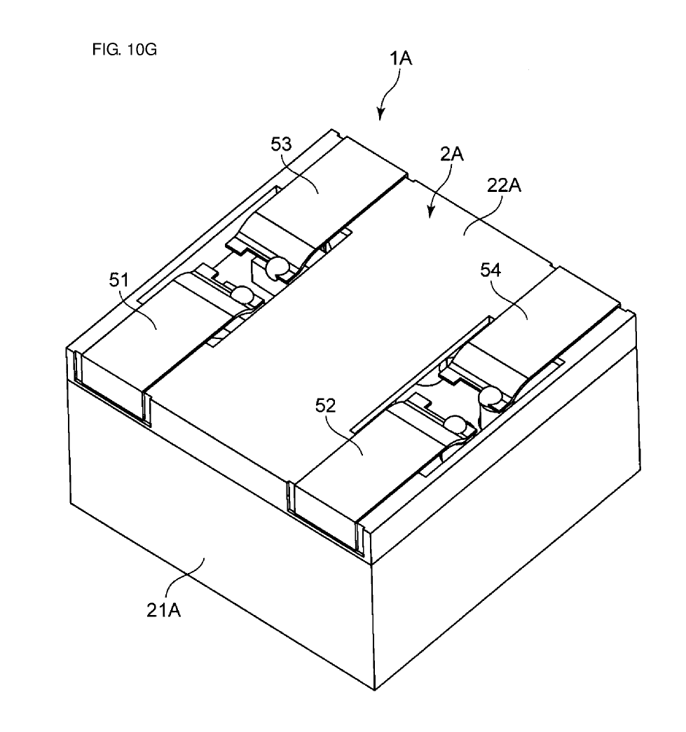

As illustrated in FIG. 10A, the holding member 8A, which has a plurality of holes 81A, is made. The holes 81A include holes that are disposed along a first circle and holes that are disposed along a second circle, which is larger than the first circle.

As illustrated in FIG. 10B, the second pin members 42 are attached to the upper surface of the holding member 8A by using an adhesive. The second pin members 42 are arranged between the holes 81A on the first circle and the holes 81A on the second circle so as to extend in the radial direction.

Subsequently, as illustrated in FIG. 10C, the holding member 8A is turned upside down, and the core 3 is placed on the holding member 8A. The second end surface 32 of the core 3 faces the holding member 8A. The second end surface 32 of the core 3 is located between the holes 81A on the first circle and the holes 81A on the second circle. That is, the holes 81A on the first circle are located inside the core 3 in the radial direction of the core 3, and the holes 81A on the second circle are located outside the core 3 in the radial direction of the core 3.

As illustrated in FIG. 10D, the plurality of first pin members 41 are fitted onto the first end surface 31 of the core 3. The first end portions 41a of the first pin members 41 are inserted into the holes 81A on the first circle, and the second end portions 41b of the first pin members 41 are inserted into the holes 81A on the second circle. Thus, the distance between first pin members 41 that are adjacent to each other in the circumferential direction of the core 3 can be easily maintained constant. It is only necessary to insert the first and second end portions 41a and 41b into the holes 81A so as to protrude from the holes 81A. In contrast to the first embodiment, it is not necessary to grind the holding member to expose the end surfaces of the first and second end portions from the holding member.

Subsequently, as illustrated in FIG. 10E, the holding member 8A is turned upside down, and the first pin members 41 and the second pin members 42 are joined together by using a joining material. At this time, the first end portions 42a of the second pin members 42 are connected to the first end portions 41a of the first pin members 41, and the second end portions 42b of the second pin members 42 are connected to the second end portions 41b of the first pin members 41. At this time, because the connection portions between the first pin members 41 and the second pin members 42 are perpendicular to the upper surface of the holding member 8A, the connection portions can be easily checked to prevent a faulty connection.

As illustrated in FIG. 10F, the cover member 22A is attached to the upper surface of the holding member 8A. The first and second end portions 431a and 432a of the primary coil 4a are connected to the first and second electrode terminals 51 and 52 through the joining members 7. The first and second end portions 431b and 432b of the secondary coil 4b are connected to the third and fourth electrode terminals 53 and 54 through the joining members 7.

Subsequently, as illustrated in FIG. 10G, the cover member 22A is attached to the opening of the box 21A. At this time, the core 3 is disposed in the box 21A.

### Third Embodiment

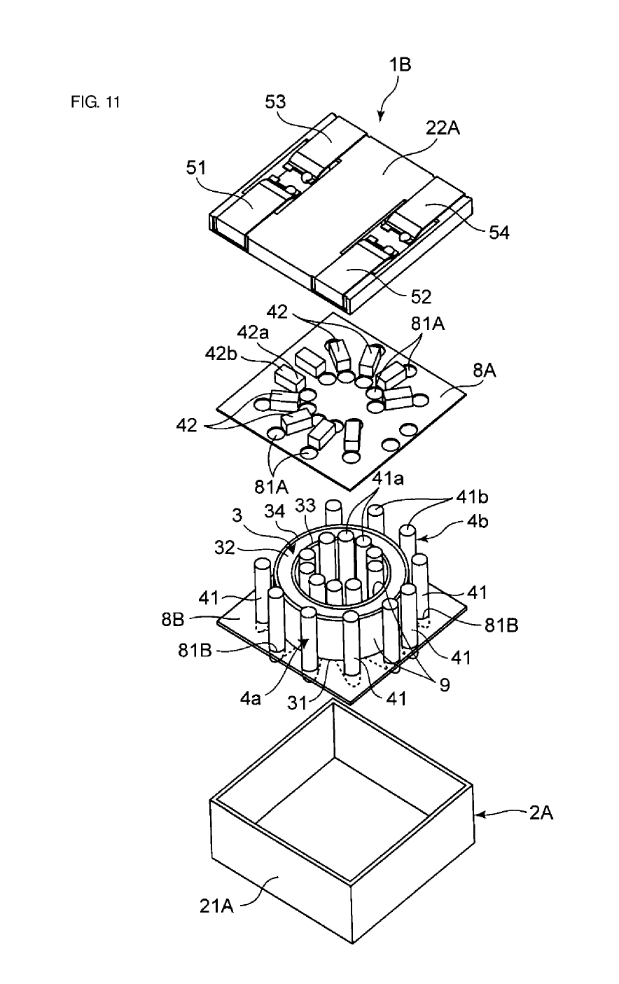

FIG. 11 is perspective view of a coil component 1B according to a third embodiment of the present disclosure. The coil component 1B according to the third embodiment differs from the coil component 1A according to the second embodiment in that the coil component 1B includes a second holding member and an insulating tape. This difference will be described below.

As illustrated in FIG. 11, the coil component 1B includes, in addition to the elements of the coil component 1B according to the second embodiment 1A, a second holding member 8B and insulating tapes 9. Elements of the coil component 1B according to the third embodiment that are the same as those of the coil component 1A according to the second embodiment will be denoted by the same numerals, and the descriptions of such elements will be omitted.

The second holding member 8B is disposed between the first end surface 31 of the core 3 and parts of the coils 4a and 4b (the first pin members 41) that face the first end surface 31 of the core 3. The structure of the second holding member 8B is the same as that of the holding member 8A in the second embodiment. A first holding member 8A is disposed between the second end surface 32 of the core 3 and parts of the coils 4a and 4b (the second pin members 42) that face the second end surface 32 of the core 3.

Linear portions of the first pin members 41, including the first and second end portions 41a and 41b, are inserted into holes 81B of the second holding member 8B. Because the second holding member 8B holds the first pin members 41, the distance between adjacent first pin members 41 can be maintained constant and variation in characteristics can be further reduced. Moreover, positioning of the first pin members 41 and the second pin members 42 can be stably performed, so that the first pin members 41 and the second pin members 42 can be more reliably joined together.

Preferably, the first and second holding members 8A and 8B are insulating substrates. In this case, the insulating substrates can electrically insulate the coils 4a and 4b from the first and second end surfaces 31 and 32 of the core 3.

As the insulating substrate, for example, a printed circuit board composed of a glass fabric, an epoxy resin, and the like is used. Thus, wiring that is to be connected to the coils 4a and 4b can be easily made, and electric components can be mounted on the printed circuit board. As the insulating substrate, for example, a substrate having a high thermal conductivity is used. Thus, heat applied to the coils 4a and 4b can be dissipated.

The insulating tapes 9 are affixed to an inner peripheral surface 33 and an outer peripheral surface 34 of the core 3. The insulating tapes 9 are adhesive tapes having electric insulation property. Examples of the material of the insulating tapes 9 include an epoxy film, a polyimide resin film, a PTFE film, and a polyester film. Accordingly, the insulating tapes 9 can electrically insulate the coils 4a and 4b from the inner peripheral surface 33 and the outer peripheral surface 34 of the core 3. Instead of insulating tapes, insulating members, such as insulation coatings, may be used.

Next, a method of making the coil component 1B will be described.

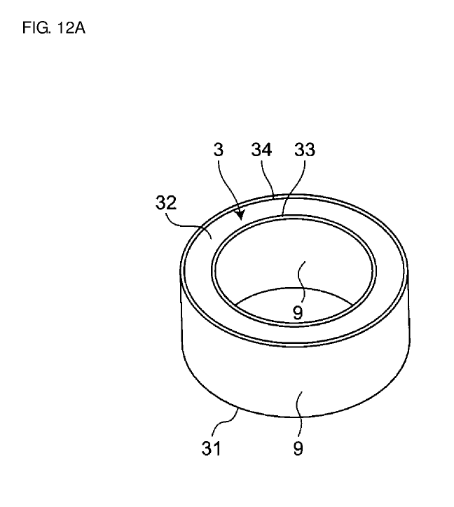

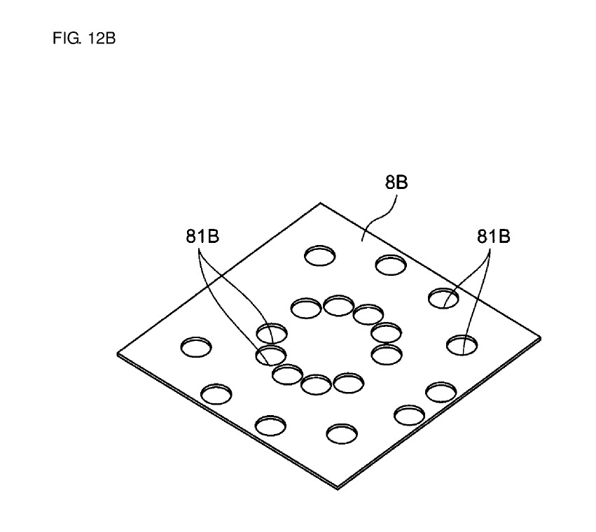

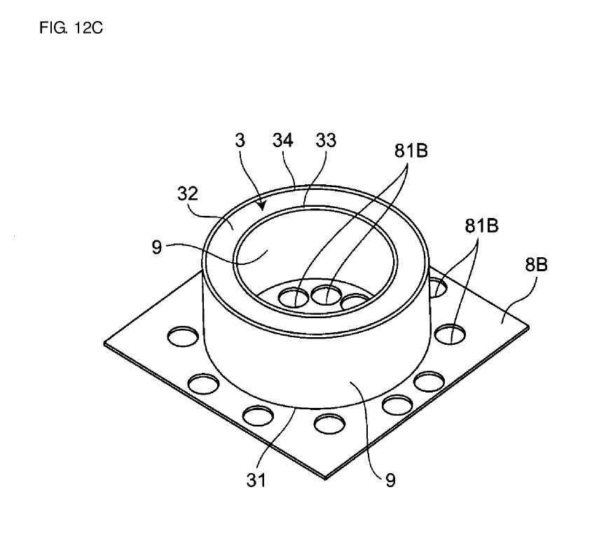

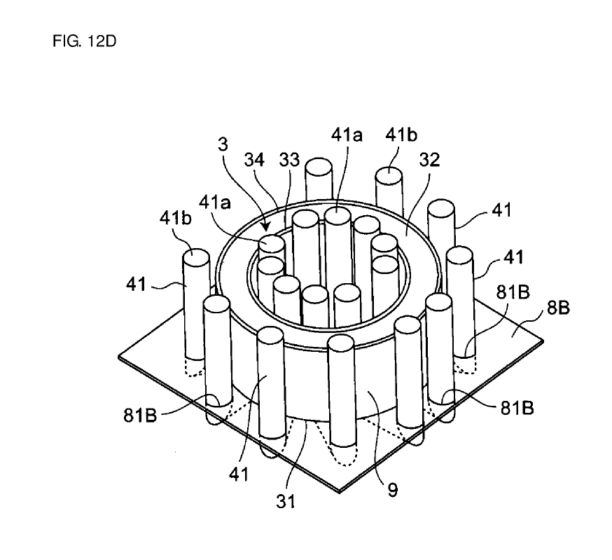

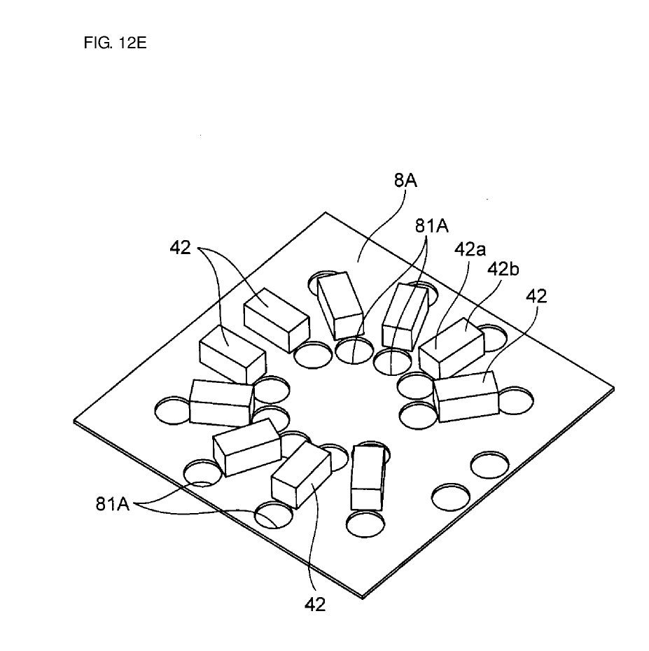

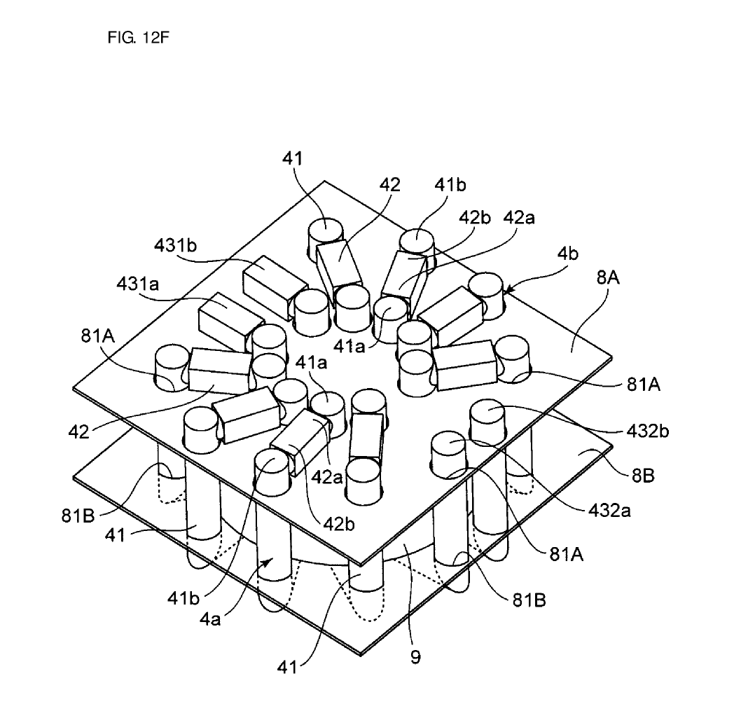

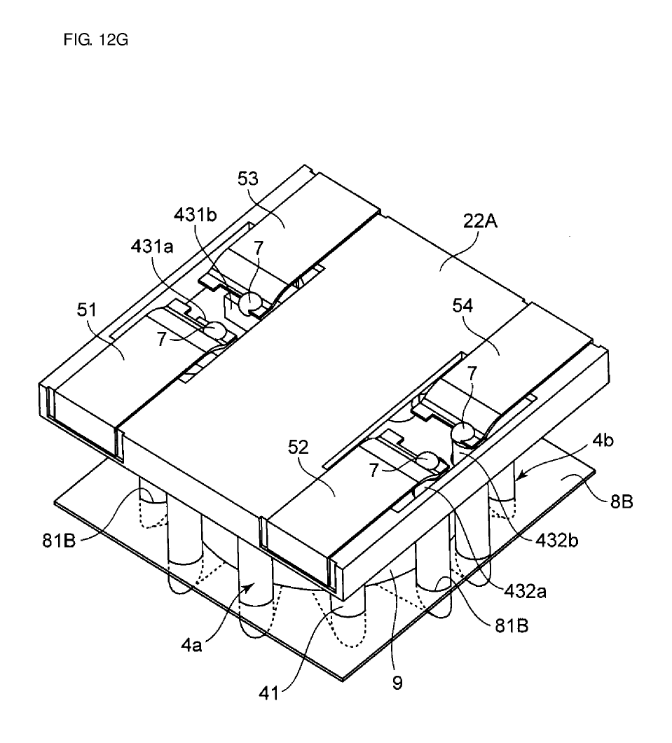

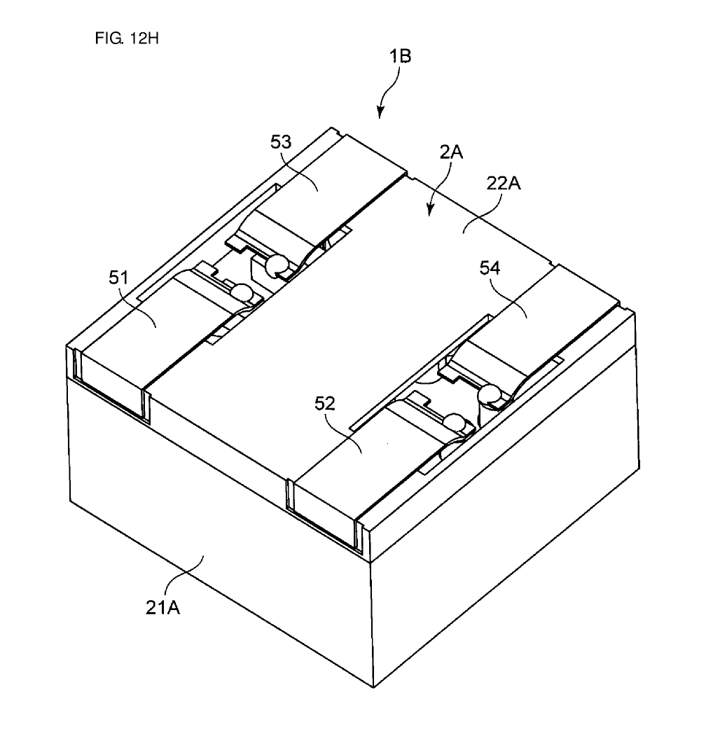

As illustrated in FIG. 12A, the insulating tapes 9 are affixed to the inner peripheral surface 33 and the outer peripheral surface 34 of the core 3. As illustrated in FIG. 12B, the second holding member 8B, which has the plurality of holes 81B, is made. The holes 81B include holes that are disposed along a first circle and holes that are disposed along a second circle, which is larger than the first circle.

As illustrated in FIG. 12C, the first end surface 31 of the core 3 is affixed to the upper surface of the second holding member 8B by using an adhesive. The first end surface 31 of the core 3 is located between the holes 81B on the first circle and the holes 81B on the second circle. That is, the holes 81B on the first circle are located inside the core 3 in the radial direction of the core 3, and the holes 81B on the second circle are located outside the core 3 in the radial direction of the core 3.

As illustrated in FIG. 12D, the plurality of first pin members 41 are inserted into the holes 81B of the second holding members 8B from the lower surface of the second holding member 8B. That is, the first end portions 41a of the first pin members 41 are inserted into the holes 81B on the first circle, and the second end portions 41b of the first pin members 41 are inserted into the holes 81B on the second circle. Thus, the distance between first pin members 41 that are adjacent to each other in the circumferential direction of the core 3 can be easily maintained constant.

As illustrated in FIG. 12E, the second pin members 42 are attached to the upper surface of the first holding member 8A by using an adhesive. The second pin members 42 are arranged between the holes 81A on the first circle and the holes 81A on the second circle so as to extend in the radial direction.

Subsequently, as illustrated in FIG. 12F, the first holding member 8A is attached to the second end surface 32 of the core 3. At this time, the plurality of first pin members 41 are inserted into the holes 81A of the first holding member 8A from the lower surface of the first holding member 8A. That is, the first end portions 41a of the first pin members 41 are inserted into the holes 81A on the first circle, and the second end portions 41b of the first pin members 41 are inserted into the holes 81A on the second circle. Thus, the distance between first pin members 41 that are adjacent to each other in the circumferential direction of the core 3 can be easily maintained constant.

As illustrated in FIG. 12G, the cover member 22A is attached to the upper surface of the first holding member 8A. The first and second end portions 431a and 432a of the primary coil 4a are connected to the first and second electrode terminals 51 and 52 through the joining members 7. The first and second end portions 431b and 432b of the secondary coil 4b are connected to the third and fourth electrode terminals 53 and 54 through the joining members 7.

Subsequently, as illustrated in FIG. 12H, the cover member 22A is attached to the opening of the box 21A. At this time, the core 3 is disposed in the box 21A.

In the third embodiment, the insulating tapes may be omitted, and the holding member may be disposed between at least one of two end surfaces of the cylindrical core in the axial direction of the core and at least parts of the coil facing the at least one of the two end surfaces of the core. In this case, the coil may be made of a wire, instead of pin members. Because the holding member holds the coil, the distance between turns of the coil in the axial direction of the coil can be maintained constant. Accordingly, in each coil component, variation in the stray capacitance in the axial direction of the coil can be reduced, and variation in characteristics can be reduced.

The present disclosure is not limited to the embodiments described above and can be modified within the spirit and scope of the present disclosure.

In the embodiments, a toroidal core is used as the core. Alternatively, a quadrangular columnar core or a circular columnar core may be used. In this case, the axial direction of the coil, which is the same as the direction in which the helix of the coil extends, coincides with the axial direction of the core. In the embodiments, a cylindrical core is used. Alternatively, an annular core may be used. The meaning of the term “annular core” includes the meaning of a core whose outer peripheral surface or inner peripheral surface is elliptical or polygonal.

In the embodiments, two coils, which are the primary coil and the secondary coil, are used. Alternatively, one coil or three or more coils may be used.

In the embodiments, pin members of two types, which are the first pin members and the second pin members, are used. Alternatively, pin members of three or more types may be used.

In the embodiments, all pin members that are adjacent to each other in the axial direction of the coil are isolated from each other with a space therebetween. Alternatively, at least some of pin members that are adjacent to each other in the axial direction of the coil may be isolated from each other with a space therebetween. Further alternatively, at least some of the pin members that are adjacent to each other in the axial direction of the coil may be isolated from each other with a conductive material therebetween.

In the embodiments, the first pin members are bent pins, and the second pin members are straight pins. Alternatively, both of the first pin members and the second pin members may be bent pins or may be straight pins. Pin members of two types may be angular pins or round pins or may be pins having different lengths.

In the embodiments, the coil component includes the holding member. Alternatively, the holding member may be omitted.

In the embodiments, the electrode terminals are attached to the case. Alternatively, for example, the case and the electrode terminals may be integrally formed by insert molding.

In the embodiments, a set of core and coil is disposed in one case. Alternatively, a plurality of sets of core and coil may be disposed in one case.

In the embodiments, the primary coil and the secondary coil are isolated from each other with a space therebetween. Alternatively, a partitioning member may be disposed between the primary coil and the secondary coil. The partitioning member has, for example, an electric insulation property, and may be made of any of a magnetic material or a non-magnetic material.

In the embodiments, in the method of making a coil component, the temporary fixing sheet, the base sheet, and the holding member are used. Alternatively, these members may be omitted. That is, it is only necessary that a method of making a coil component include a step of attaching a plurality of first pin members to a core; and a step of forming a coil, which is wound around the core, from the plurality of first pin members and a plurality of second pin members by joining the second pin members to the first pin members so that the first pin members and the second pin members are alternately arranged.

While preferred embodiments of the disclosure have been described above, it is to be understood that variations and modifications will be apparent to those skilled in the art without departing from the scope and spirit of the disclosure. The scope of the disclosure, therefore, is to be determined solely by the following claims.

What is claimed is:

1. A coil component comprising:
a core; and
a coil that is wound around the core,
wherein the coil includes a plurality of pin members that are joined together.

2. The coil component according to claim 1,
wherein the plurality of pin members are joined together by using a joining material.

3. The coil component according to claim 1,
wherein at least some of the pin members that are adjacent to each other in an axial direction of the coil are isolated from each other with a space therebetween.

4. The coil component according to claim 1,
wherein at least some of the pin members that are adjacent to each other in an axial direction of the coil are isolated from each other with a dielectric material therebetween.

5. The coil component according to claim 1,
wherein the plurality of pin members include a plurality of first pin members and a plurality of second pin members, and
wherein the first pin members and the second pin members have different shapes and are alternately joined together.

6. The coil component according to claim 5,
wherein the first pin members are bent pins that are substantially U-shaped and the second pin members are straight pins that extend substantially straight.

7. The coil component according to claim 1,
wherein the core is annular, and
wherein the coil component further comprises a holding member that holds the coil, the holding member being disposed between at least one of two end surfaces of the core in an axial direction of the core and a part of the coil that faces the at least one of the two end surfaces of the core.

8. The coil component according to claim 7,
wherein the holding member is disposed between each of the two end surfaces of the core in the axial direction of the core and a part of the coil that faces a corresponding one of the two end surfaces of the core.

9. The coil component according to claim 7,
wherein the holding member is an insulating substrate.

10. The coil component according to claim 9, further comprising:
an insulating member that is disposed on each of an inner peripheral surface and an outer peripheral surface of the core.

11. The coil component according to claim 10,
wherein the insulating member is an insulating tape.

12. A coil component comprising:
an annular core;
a coil that is wound around the core; and
a holding member that holds the coil, the holding member being disposed between at least one of two end surfaces of the core in an axial direction of the core and a part of the coil that faces the at least one of the two end surfaces of the core.

13. The coil component according to claim 12,
wherein the holding member is disposed between each of the two end surfaces of the core in the axial direction of the core and a part of the coil that faces a corresponding one of the two end surfaces of the core.

14. The coil component according to claim 12,
wherein the holding member is an insulating substrate.

15. The coil component according to claim 14, further comprising:
an insulating member that is disposed on each of an inner peripheral surface and an outer peripheral surface of the core.

16. The coil component according to claim 15,
wherein the insulating member is an insulating tape.

17. The coil component according to claim 12,
wherein the coil includes a plurality of pin members that are joined together.

18. A method of making a coil component, the method comprising:
attaching a plurality of first pin members to a core; and
forming a coil, which is wound around the core, from the plurality of first pin members and a plurality of second pin members by joining the second pin members to the first pin members so that the first pin members and the second pin members are alternately arranged.
